(19) United States
(12) Patent Application Publication
(10) Pub. No.: US 2024/0074929 A1
(43) Pub. Date: Mar. 7, 2024

(54) Kit for Selectively Constructing a Floor of a Packing Rack and a Horizontal Transfer Lift and a Method for Converting a Floor of a Packing Rack Into a Horizontal Transfer Lift

(71) Applicant: Jun Shangguan, Changting (CN)

(72) Inventor: Jun Shangguan, Changting (CN)

(21) Appl. No.: 17/902,837

(22) Filed: Sep. 4, 2022

(51) Int. Cl. A61G 7/10

(52) U.S. Cl. CPC A61G 7/1073; A61G 7/1025

(57) ABSTRACT

A kit for selectively constructing a floor of a packing rack and a horizontal transfer lift, and a method for converting a floor of a packing rack and a horizontal transfer lift. The kit includes a first rod, a second rod, a third rod, a fourth rod, a support base, a first beam, a second beam, a third beam, and a fourth beam, and a hooked motion unit.

### FIELD OF THE INVENTION

The present invention, in some embodiments thereof, relates to horizontal lifts for carrying targets from one location to another. More specifically, the present invention relates to horizontal lifts for carrying people who cannot get up by themselves from a from one location to another, such as from a bed to a wheelchair and viceversa.

### BACKGROUND OF THE INVENTION

Low Speed Vehicles (LSVs) and other heavy equipment are shipped to their destination after they are produced. Generally, such vehicles or equipment are shipped in a container in which packing racks are installed. The packing racks are sturdy and expensive. After the vehicles are shipped, the packing racks are generally thrown away as waste.

### BRIEF SUMMARY OF EMBODIMENTS OF THE INVENTION

An aim of the present patent application is to reuse packing racks that are thrown away to build horizontal transfer lifts. These horizontal transfer lifts can be used to move an object from one location to the other. Horizontal transfer lifts are generally located in care homes or residences of wheelchaired people to move people from their beds to their wheelchairs, and vice-versa.

Horizontal transfer lifts are generally very expensive. Therefore, reusing packaging racks to build horizontal transfer lifts can be beneficial to lower the manufacture cost (and therefore the retail cost) of horizontal transfer lifts.

An aspect of some embodiments of the present invention relates to a method for converting a floor of a packing rack into a horizontal transfer lift. The method includes: (i) providing a packing rack having at least one floor, wherein each floor comprising a first rod, a second rod, a third rod, a fourth rod forming a horizontal rectangular frame, wherein the first rod and the second rod are parallel to each other, while the third rod and the fourth rod are parallel to each other and orthogonal to the first rod and to the second rod; a support base extending from the third rod to the fourth rod inside the rectangular frame; a first beam, a second beam, a third beam, and a fourth beam extending vertically from respective corners of the rectangular frame; (ii) disassembling one floor of the packing rack; (iii) positioning the first rod vertically to form a first vertical column; (iv) positioning the second rod vertically to form a second vertical column; (v) joining the support base to the first vertical column and the second vertical column, such that the support base extends from the first vertical column to the second vertical column at a desired height; (vi) joining a hooked motion unit to the support base, such that the hooked motion unit is configured to move horizontally along the support base, the hooked motion unit having a hook configured to be joined to straps attached to a target, such that a motion of hooked motion unit is configured to carry the target horizontally between a first location in a vicinity of the first vertical column and second location in a vicinity of the second vertical column.

In a variant, the method further comprises: joining the first vertical column to the third rod, such that the third rod is disposed horizontally below the first vertical column and provides a first base; and joining the second vertical column to the fourth rod, such that the fourth rod is disposed horizontally below the second vertical column and provides a second base.

In another variant, the support base is telescopically extendible and contractable and the method further comprises between steps (v) and (vi): telescopically extending or contracting the support base to adjust a horizontal length of the support base; locking the support base at a desired horizontal length.

In yet another variant, the first rod and the second rod are telescopically extendible and contractable and wherein the method further comprises: telescopically extending or contracting the first rod to adjust a vertical height of the first vertical column; locking the first rod at a desired vertical height of the first vertical column; telescopically extending or contracting the second rod to adjust a vertical height of the second vertical column; and locking the second rod at a desired vertical height of the second vertical column.

In a further variant, positioning the first rod vertically to form a first vertical column further comprises joining at least one of the first beam, the second beam, and the third rod to the first rod along longitudinal axes thereof to form the first vertical column; positioning the second rod vertically to form a second vertical column further comprises joining at least one of the third beam, the fourth beam, and the fourth rod to the second rod along longitudinal axes thereof to form the second vertical column.

In yet a further variant, the method includes: securing a bottom edge of the first vertical column to a floor; securing a top edge of the first vertical column to a ceiling; securing a bottom edge of the second vertical column to the floor; securing a top edge of the second vertical column to the ceiling.

In a variant, the third rod comprises a first central attachment unit, a first rear attachment unit, and a first front attachment unit, which extend from a side of the third rod which extends parallel of a longitudinal axis of the third rod; the first central attachment unit is between the first rear attachment unit and the first front attachment unit. Joining the first vertical column to the third rod includes: joining the first rod to the third rod via the first central attachment unit; joining a first end of the first beam to the third rod obliquely via the first rear attachment unit, such that a second end of the first beam touches the first rod; joining the second end of the first beam to the first rod; joining a first end of the second beam to the third rod obliquely via the first front attachment unit, such that a second end of the second beam touches the first rod; joining the second end of the second beam to the first rod. The fourth rod comprises a second central attachment unit, a second rear attachment unit, and a second front attachment unit, which extend from a side of the fourth rod which extends parallel of a longitudinal axis of the fourth rod; the second central attachment unit is between the second rear attachment unit and the second front attachment unit. Joining the second vertical column to the fourth rod, comprises: joining the second rod to the fourth rod via the second central attachment unit; joining a first end of the third beam to the fourth rod obliquely via the second rear attachment unit, such that a second end of the third beam touches the second rod; joining the second end of the third beam to the second rod; joining a first end of the fourth beam to the fourth rod obliquely via the second front attachment unit, such that a second end of the fourth beam touches the second rod; joining the second end of the fourth beam to the second rod.

In a variant, the hooked motion unit comprises: a board; at least one roller joined to a same surface of the board and extending out of the board; and the hook, joined to the board. Joining a hooked motion unit to the support base comprises placing the at least one roller on top of the support base, such that a rolling of the roller causes the hooked motion unit to travel along the support base.

In another variant, the hooked motion unit comprises a motor configured to selectively rotate the at least one roller in any one of two directions.

Another aspect of some embodiments of the present invention relates to a kit for selectively constructing a floor of a packing rack and a horizontal transfer lift, the kit comprising a first rod, a second rod, a third rod, a fourth rod, a support base, a first beam, a second beam, a third beam, and a fourth beam, and a hooked motion unit. In a configuration of the floor of the packing rack: the first rod, the second rod, the third rod, and the fourth rod form a horizontal rectangular frame, wherein the first rod and the second rod are parallel to each other, while the third rod and the fourth rod are parallel to each other and orthogonal to the first rod and to the second rod; the support base extends from the third rod to the fourth rod inside the rectangular frame; the first beam, the second beam, the third beam, and the fourth beam extend vertically from respective corners of the rectangular frame. In a configuration of the horizontal transfer lift: the first rod is disposed vertically to form a first vertical column; the second rod is disposed vertically to form a second vertical column; the support base is joined to the first vertical column and to the second vertical column, such that the support base extends from the first vertical column to the second vertical column at a desired height; the hooked motion unit is joined to the support base, such that the hooked motion unit is configured to move horizontally along the support base, the hooked motion unit having a hook configured to be joined to straps attached to a target, such that a motion of hooked motion unit is configured to carry the target horizontally between a first location in a vicinity of the first vertical column and second location in a vicinity of the second vertical column.

In another variant, in the configuration of the horizontal transfer lift: the first vertical column is joined to the third rod, such that the third rod is disposed horizontally below the first vertical column and provides a first base; and the second vertical column is joined to the fourth rod, such that the fourth rod is disposed horizontally below the second vertical column and provides a second base.

In yet another variant, the support base is telescopically extendible and contractable to adjust a horizontal length of the support base, and is lockable at a desired horizontal length.

In a further variant, the first rod and the second rod are telescopically extendible and contractable and in the configuration of the horizontal transfer lift: the first rod is telescopically extendable or contractable to adjust a vertical height of the first vertical column; the first rod is lockable the at a desired vertical height of the first vertical column; the second rod is telescopically extendable or contractable to adjust a vertical height of the second vertical column; the second rod is lockable the at a desired vertical height of the second vertical column.

In yet a further variant, the first vertical column is formed by joining at least one of the first beam, the second beam, and the third rod to the first rod along longitudinal axes; the second vertical column is formed by joining at least one of the third beam, the fourth beam, and the fourth rod to the second rod along longitudinal axes thereof.

In a variant, in the in the configuration of the horizontal transfer lift: a bottom edge of the first vertical column is securable to a floor; a top edge of the first vertical column to is securable a ceiling; a bottom edge of the second vertical column is securable to the floor; a top edge of the second vertical column is securable to the ceiling.

In a variant, the third rod comprises a first central attachment unit, a first rear attachment unit, and a first front attachment unit, which extend from a side of the third rod which extends parallel of a longitudinal axis of the third rod; the first central attachment unit is between the first rear attachment unit and the first front attachment unit. In the in the configuration of the horizontal transfer lift: the first rod is joined to the third rod via the first central attachment unit; a first end of the first beam is joined to the third rod obliquely via the first rear attachment unit, such that a second end of the first beam touches the first rod; the second end of the first beam to joined the first rod; a first end of the second beam is joined to the third rod obliquely via the first front attachment unit, such that a second end of the second beam touches the first rod; the second end of the second beam is joined to the first rod. The fourth rod comprises a second central attachment unit, a second rear attachment unit, and a second front attachment unit, which extend from a side of the fourth rod which extends parallel of a longitudinal axis of the fourth rod; the second central attachment unit is between the second rear attachment unit and the second front attachment unit. In the configuration of the horizontal transfer lift: the second rod is joined to the fourth rod via the second central attachment unit; a first end of the third beam is joined to the fourth rod obliquely via the second rear attachment unit, such that a second end of the third beam touches the second rod; the second end of the third beam is joined to the second rod; a first end of the fourth beam is joined to the fourth rod obliquely via the second front attachment unit, such that a second end of the fourth beam touches the second rod; the second end of the fourth beam is joined to the second rod.

In another variant, the hooked motion unit comprises: a board; at least one roller joined to a same surface of the board and extending out of the board; and the hook, joined to the board. In the configuration of the horizontal transfer lift, the at least one roller is placed on top of the support base, such that a rolling of the roller causes the hooked motion unit to travel along the support base.

In yet another variant, the hooked motion unit comprises a motor configured to selectively rotate the at least one roller in any one of two directions.

### BRIEF DESCRIPTION OF DRAWINGS

FIG. 1 illustrates a multi-floor packing rack as used in the prior art;

FIG. 2 is an exploded view of the multi-floor packing rack of FIG. 1;

FIG. 3 illustrates a multi-floor packing rack, according to some embodiments of the present invention;

FIG. 4 is an exploded view of the multi-floor packing rack of FIG. 3, according to some embodiments of the present invention;

FIG. 5 illustrates a single floor of the packing rack of FIGS. 3 and 4 according to some embodiments of the present invention;

FIG. 6 illustrates a horizontal transfer lift manufactured from the parts of a floor of a packing rack, according to some embodiments of the present invention;

FIG. 7 illustrates a modified floor of a packing rack in which the first rod, second rod, and support base are telescopic, according to some embodiments of the present invention;

FIG. 8 illustrated a horizontal transfer lift manufactured by using some of the parts of the modified packing rack floor of FIG. 7, according to some embodiments of the present invention;

FIG. 9 illustrated a horizontal transfer lift manufactured by using all of the parts of the modified packing rack floor of FIG. 7, according to some embodiments of the present invention;

FIG. 10 illustrates a floor of a packing rack, modified so as to use the parts floor of the packing rack to build a horizontal transfer lift with enhanced stability, according to some embodiments of the present invention;

FIG. 11 illustrates an enhanced horizontal transfer lift built with parts from the packing rack of FIG. 10, according to some embodiments of the present invention;

FIG. 12 illustrates a kit for selectively constructing a floor of a packing rack and a horizontal transfer lift, according to some embodiments of the present invention; and

FIG. 13 illustrates a hooked motion unit in which the roller(s) is (are) grooved, according to some embodiments of the present invention.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

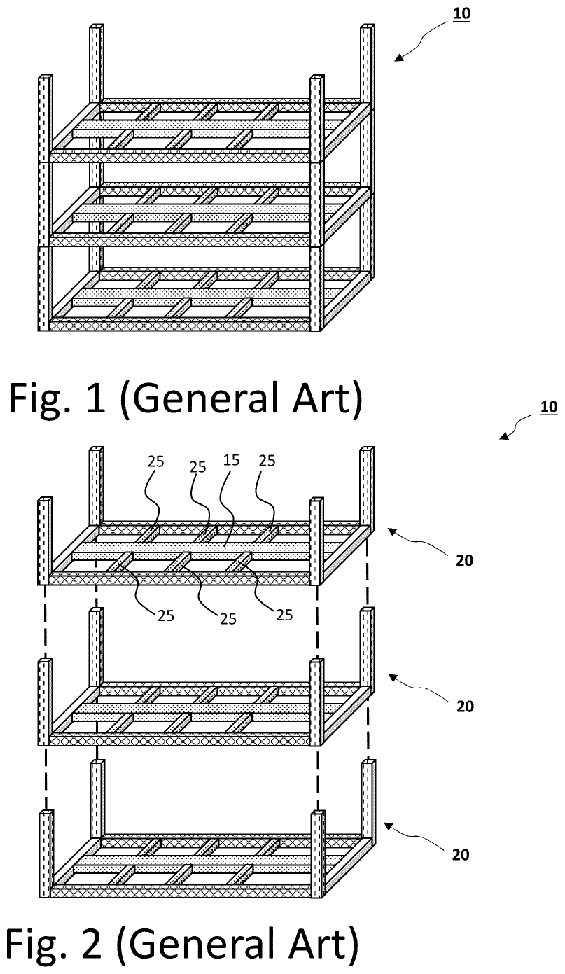

FIG. 1 illustrates a multi-floor packing rack 10 as used in the prior art FIG. 2 is an exploded view of the multi-floor packing rack of FIG. 1 comprising multiple floors 20.

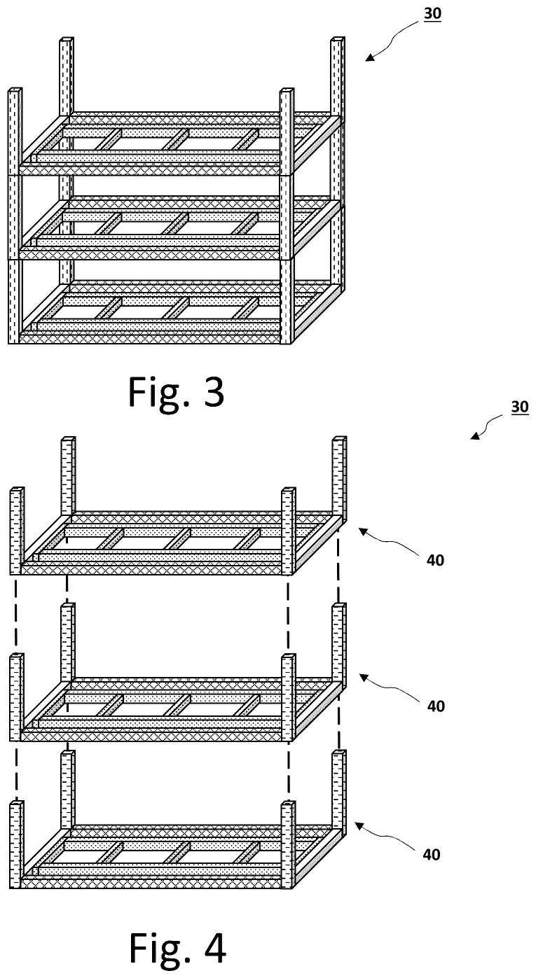

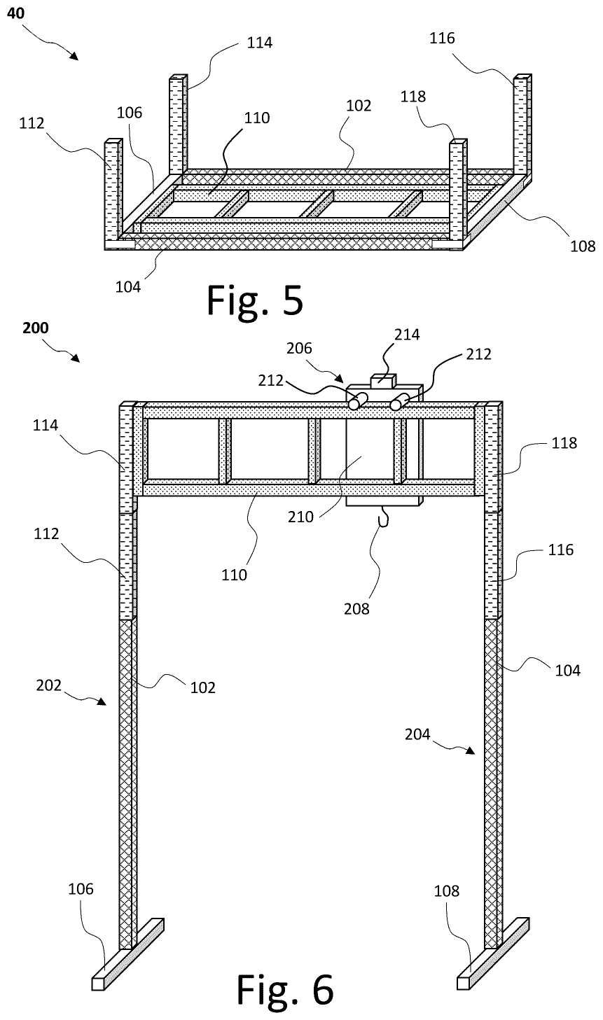

FIG. 3 illustrates a multi-floor packing rack according to some embodiments of the present invention. FIG. 2 is an exploded view of the multi-floor packing rack of FIG. 3. FIG. 5 illustrates a single floor of the packing rack of FIGS. 3 and 4.

The multi-floor packing rack 30 includes multiple floors 40. Each of the floors is configured to support and keep a respective object (such as an LSV, for example) in place during the shipping of the object.

Each floor 40 includes a first rod 102, a second rod 104, a third rod 106, a fourth rod 108, a support base 110, a first beam 112, a second beam 114, a third beam 116, and a fourth beam 118.

The first rod 102, second rod 104, third rod 106, and fourth rod 108 form together a horizontal rectangular frame. The first rod 102 and the second rod 104 are parallel to each other, while the third rod 106 and the fourth rod 108 are parallel to each other and orthogonal to the first rod 102 and to the second rod 104.

The support base 110 extends from the third rod to the fourth rod inside the rectangular frame. The support base is configured to provide support to the object placed on the rack's floor 40.

The first beam 112, second beam 114, third beam 116, and fourth beam 118 extend vertically from respective corners of the rectangular frame. The top portions of the beams 112-118 may be joined to a further floor and provide support for the floor(s) placed thereupon.

It should be noted that the support base 110 of the floor 40 differs from the corresponding support element 15 in the floor 20 of the general art. The support base 110 is sturdier and wider than its general art counterpart 15, and provides support just by being connected to the third and fourth rod. Instead, in the general art, the counterpart 15 of the support base needs to be supported by bars 25.

As will be seen further below this is an important factor in using the support base 110 in a transfer lift 200.

FIG. 6 illustrates a horizontal transfer lift 200 manufactured from the parts of a floor 40 of a packing rack (of FIG. 5), according to some embodiments of the present invention.

In order to build the horizontal transfer lift 200, the floor 40 of FIG. 5 is disassembled into its components, i.e., the first rod 102, the second rod 104, the third rod 106, the fourth rod 108, the support base 110, the first beam 112, the second beam 114, the third beam 116, and the fourth beam 118. In some embodiments of the present invention, as will be seen further below, there is no need to separate the support base 110 from the third rod 106 and the fourth rod 108.

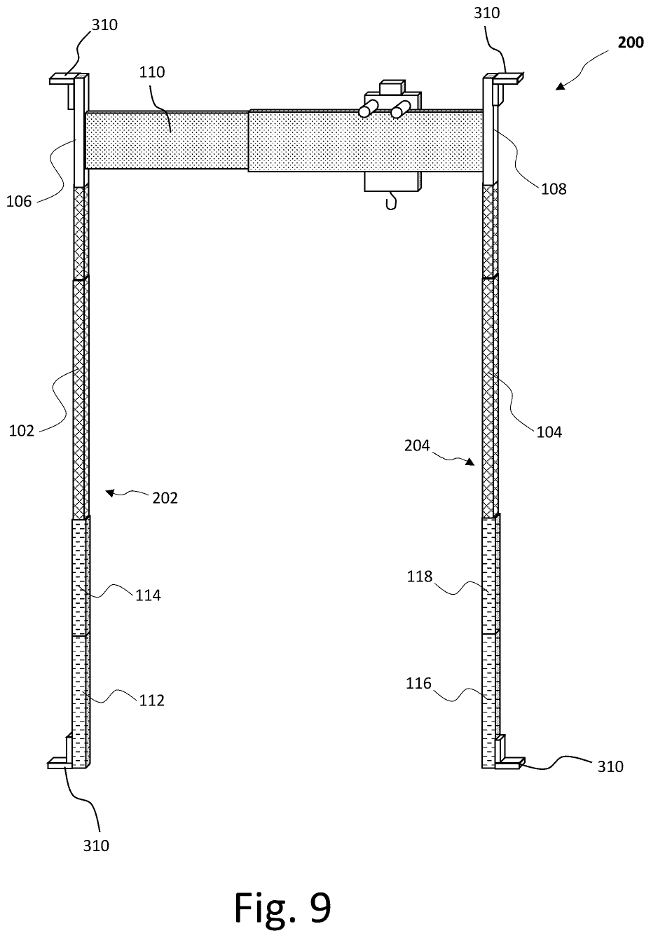

Once the floor has been disassembled, the first rod 102 is disposed vertically to form a first vertical column 202, while the second rod 104 is disposed vertically to form a second vertical column 204. The first column 202 may be formed by further joining at least one of the first beam 112 (FIGS. 6 and 9), the second beam 114 (FIGS. 6 and 9), and the third rod 106 (FIGS. 8 and 9) to the first rod 102 along longitudinal axes thereof. The second column 204 may be formed by further joining at least one of the third beam 116, the fourth beam 118, and the fourth rod 108 to the second rod 104 along longitudinal axes thereof.

The support base 110 is joined the first vertical column 202 and to the second vertical column 204, such that the support base 110 extends from the first vertical column 202 to the second vertical column 204 at a desired height.

In some embodiments of the present invention, the third rod 106 is joined to first vertical column 202, such that the third rod 106 is disposed horizontally below the first vertical column 202. The third rod 106 may be not parallel (for example, orthogonal to) to the support base 110. In this manner, the third rod 106 provides a first base. In some embodiments of the present invention, the fourth rod 108 is joined to second vertical column 204, such that the fourth rod 108 is disposed horizontally below the second vertical column 204. The fourth rod 108 may be not parallel (for example, orthogonal to) to the support base 110. In this manner, the fourth rod 108 provides a second base. The third rod 106 and the fourth rod 108 provide stability to the horizontal transfer lift 200.

Thus far, the components of one floor of the packing rack have been used to form the frame of the horizontal transfer lift 200. In order to complete the horizontal transfer lift 200, a hooked motion unit 206 is required. This element is generally not part of packing racks, and is provided separately. The hooked motion unit 206 is joined to the support base 110, such that the hooked motion unit 206 is configured to move horizontally along the support base 100. The hooked motion unit has a hook 208 configured to be joined to straps attached to a target, such that a motion of hooked motion unit 206 is configured to carry the target (e.g., a person) horizontally between a first location (occupied by a bed, for example) in a vicinity of the first vertical column 202 and second location (occupied by a wheelchair, for example) in a vicinity of the second vertical column 204. As mentioned above, the support base 110 needs to be sturdy, so as to be able to support the weight of the hooked motion unit 206, the straps, and the target.

The horizontal transfer lift 200 may be used to transfer a person between a bed located in a first room and wheelchair located outside the first room, or in a second room connected to the first room through a hallway which is hard to navigate by wheelchair.

In some embodiments of the present invention, the hooked motion unit 206 includes a board 210, at least one roller 212, and the hook 208 joined to the board. The at least one roller 212 is joined to a surface of the board and extends away (for example perpendicularly) from the board 210. The at least one roller 212 is placed on top of the support base 110, such that a rolling of the at least one roller 212 causes the hooked motion unit 206 to travel along the support base 108. In some embodiments of the present invention, as seen in the example of FIG. 13, the at least one roller 212 is grooved, such that the grooved section of the roller 212 is supported by the support base 110, while the wider (ungrooved) sections of the roller 212 are disposed on both ends of the grooved section in the vicinity of respective sides of the support base 110. In this manner, the hooked motion unit 206 is more securely disposed on the support base 110.

In some embodiments of the present invention, the hooked motion unit 206 includes a motor 214 configured to selectively rotate the at least one roller 212 in any one of two directions. The hooked motion unit may include one roller, two rollers, or a plurality of rollers aligned with each other.

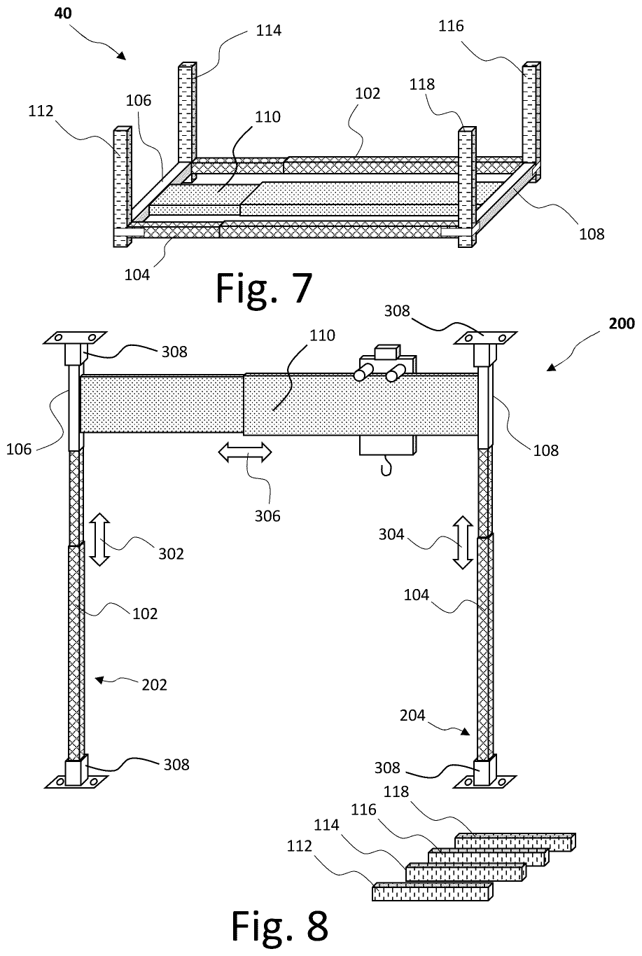

FIG. 7 illustrates a modified floor of a packing rack in which the first rod and second rod are telescopic, according to some embodiments of the present invention. FIG. 8 illustrated a horizontal transfer lift manufactured by using some of the parts of the modified packing rack floor of FIG. 7, according to some embodiments of the present invention. FIG. 9 illustrated a horizontal transfer lift manufactured by using all of the parts of the modified packing rack floor of FIG. 7, according to some embodiments of the present invention.

The floor 40 of FIG. 7 is modified from the prior art. As explained above, the floor 40 includes a first rod 102, a second rod 104, a third rod 106, a fourth rod 108, a support base 110, a first beam 112, a second beam 114, a third beam 116, and a fourth beam 118 arranged as explained above. However, in FIG. 7, the first rod 102, the second rod 104, and optionally the support base 110 are telescopic.

If the first rod 102, the second rod 104, and the support base 110 are all telescopic, the floor 40 can be adapted to containers or vehicles of different sizes. Furthermore, when the floor 40 is reassembled as a horizontal transfer lift 200 (FIGS. 8 and 9), both the height and the width of the horizontal transfer lift 200 can be changed to fit the horizontal transfer lift 200 to different sized rooms, as shown by the double arrows 302, 304, and 306.

If only the first rod 102 and the second rod 104 are all telescopic, when the floor 40 is reassembled as a horizontal transfer lift 200 (FIGS. 8 and 9), the only the height of the horizontal transfer lift 200 can be changed to fit the horizontal transfer lift 200 to different sized rooms.

As explained above, in the horizontal transfer lift 200, the first vertical column 202 includes the first rod 102 and may further include one or more of the first beam 112, the second beam 114, and the third rod 106. The second vertical column 204 includes the second rod 104 and may further include one or more of the third beam 116, the fourth beam 118, and the fourth rod 108.

In the example of FIG. 8, the first column 202 includes the first rod 102 and the third rod 106 (though this is not required, and the first column 202 may solely include the first rod 102), while the second column 204 includes the second rod 104 and the fourth rod 108 (though this is not required, and the second column 204 may solely include the second rod 204). The support base 110 is joined to the third rod 106 and fourth rod 108. An advantage of this configuration lies in the fact that the support base 110 does not need to be detached from the third rod 106 and the fourth rod 108 and then reattached to other rods or beams. In the example of FIG. 8, the height of the horizontal transfer lift 200 is required to be limited, so the beams 112, 114, 116, and 118 are not used.

In the example of FIG. 9, the height of the horizontal transfer lift 200 is required to be larger. Therefore, the beams 112 and 114 are joined to the first rod 102 and the third rod 106 to form the first vertical column 202, while the beams 116 and 118 are joined to the second rod 104 and the fourth rod 108 to form the second vertical column 204. Like the horizontal transfer lift 200 of FIG. 8, also in FIG. 9 the support base 110 is joined to the third rod 106 and fourth rod 108. Thus, the support base 110 does not need to be detached from the third rod 106 and the fourth rod 108 and then reattached to other rods or beams.

In some embodiments of the present invention, the first vertical column 202 and the second vertical column 204 are secured to the floor and to the ceiling of a room. This may be accomplished, for example, via T-shaped connectors 308 (FIG. 8) which are joined to the end portions of the vertical columns 202 and 204, each T-shaped connector having a flat plate configured to abut the floor or ceiling and having at least one hole for bolting the flat plate to the floor or ceiling. In another embodiment, the vertical columns 202 and 204 are secured to the floor and ceiling via L-shaped connectors 310 (FIG. 9). Each L-shaped connector has a first plate and a second plate perpendicular to each other, such that the first plate is designed to be joined (e.g., bolted or screwed) to the respective vertical column, while the second plate is designed to be joined (e.g., bolted or screwed) to the ceiling or floor. It should be noted that other techniques are known in the art for securing a column to the floor and ceiling, and the scope of the present invention extends to such techniques. It should also be noted that the L-shaped connectors 310 of FIG. 9 can be used in the embodiment of FIG. 8, instead of the T-shaped connectors 308. Conversely, the T-shaped connectors 308 of FIG. 8 can be used in the embodiment of FIG. 9, instead of the L-shaped connectors 310.

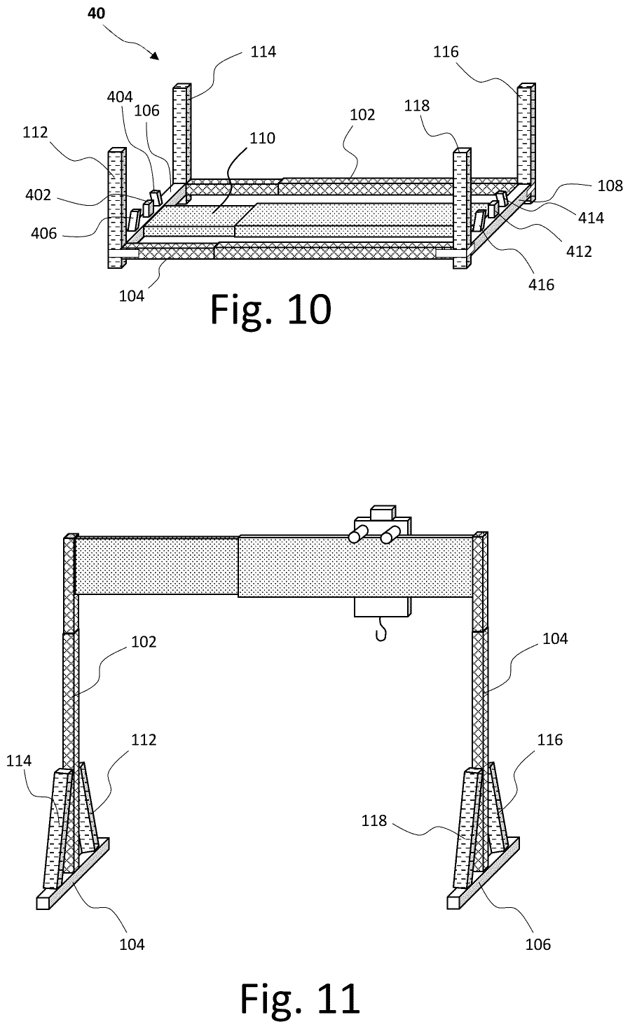

FIG. 10 illustrates a floor of a packing rack 40, modified so as to use the parts floor of the packing rack to build a horizontal transfer lift 200 with enhanced stability, according to some embodiments of the present invention. FIG. 11 illustrates an enhanced horizontal transfer lift 202 built with parts from the packing rack of FIG. 10, according to some embodiments of the present invention.

In the example of FIGS. 10 and 11, the third rod 106 comprises a first central attachment unit 402, a first rear attachment unit 404, and a first front attachment unit 406, which extend from a side of the third rod which extends parallel of a longitudinal axis of the third rod. The first central attachment unit 402 is disposed between the first rear attachment unit 404 and the first front attachment unit 406. The fourth rod 108 comprises a second central attachment unit 412, a second rear attachment unit 414, and a second front attachment unit 416, which extend from a side of the fourth rod which extends parallel of a longitudinal axis of the fourth rod. In some embodiments of the present invention, the first central attachment unit 402 extends perpendicularly to the third rod 106. The first rear attachment unit 404 and the first front attachment unit 406 extend obliquely from the third rod 106 and toward each other. In some embodiments of the present invention, the second central attachment unit 412 extends perpendicularly to the fourth rod 108. The second rear attachment unit 414 and the second front attachment unit 416 extend obliquely from the fourth rod 108 and toward each other.

When the floor 40 is reassembled as a horizontal transfer lift 200, the first rod 102 is joined to the third rod 106 via the first central attachment unit 402. A first end of the first beam 112 is joined (e.g., screwed, bolted, welded) to the third rod 106 obliquely via the first rear attachment unit 404, such that a second end of the first beam 112 touches the first rod 102 and the second end of the first beam 112 is joined (e.g., screwed, bolted, welded) the first rod 102. A first end of the second beam 114 is joined to the third rod 106 obliquely via the first front attachment unit 406, such that a second end of the second beam 114 touches the first rod 102 and is joined to the first rod 102.

Similarly, the second rod 104 is joined to the fourth rod 108 via the second central attachment unit 412. A first end of the third beam 116 is joined to the fourth rod 108 obliquely via the second rear attachment unit 414, such that a second end of the third beam 116 touches the second rod 104 and is joined to the second rod 104. A first end of the fourth beam 118 is joined to the fourth rod 108 obliquely via the second front attachment unit 416, such that a second end of the fourth beam 118 touches the second rod 104 and is joined to the second rod 104.

In this manner, the first rod 102 is supported from opposite sides thereof to remain in a vertical position by the first beam 112 and the second beam 114, while the second rod 104 is supported from opposite sides thereof to remain in a vertical position by the third beam 116 and the fourth beam 118.

It should be noted that in FIGS. 10 and 11, the first rod 102, the second rod 104, and support base 110 are shown to be telescopic. However, the first rod 102, the second rod 104, and support base 110 need not be telescopic.

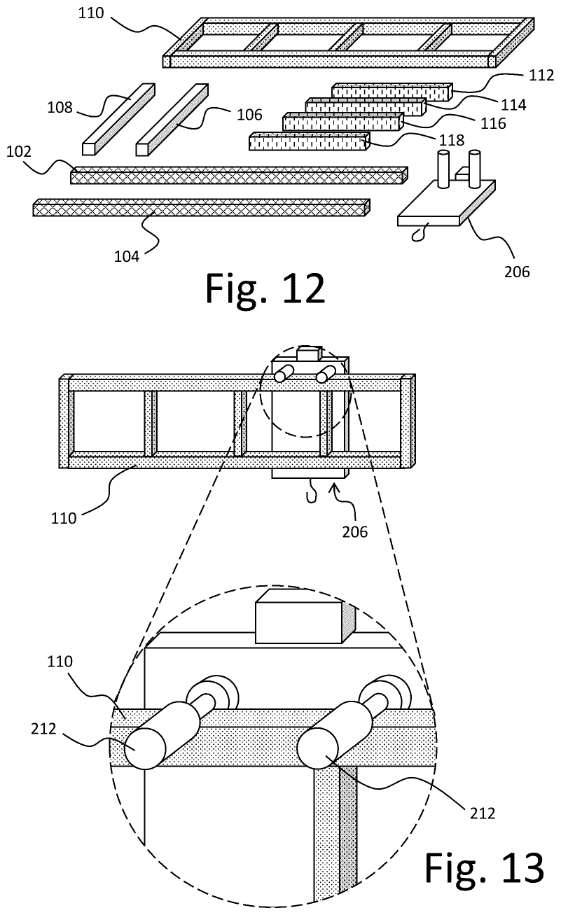

FIG. 12 illustrated a kit 500 for selectively constructing a floor of a packing rack and a horizontal transfer lift, according to some embodiments of the present invention.

The kit 500 includes a first rod 102, a second rod 104, a third rod 106, a fourth rod 108, a support base 110, a first beam 112, a second beam 114, a third beam 116, a fourth beam 118, and a hooked motion unit 206, as described above. These elements have the features described above and may be used to build a floor of a packing rack or a horizontal transfer lift, as described above.

In some embodiments of the present invention the first rod 102 and the second rod 104 are telescopic. In some embodiments of the present invention, the support base 110 is telescopic. In some embodiments of the present invention, the third rod 106 includes a first central attachment unit, a first rear attachment unit, and a first front attachment unit, as described above. In some embodiments of the present invention, the fourth rod 108 comprises a second central attachment unit, a second rear attachment unit, and a second front attachment unit, as described above.

Although the invention is described above in terms of various exemplary embodiments and implementations, it should be understood that the various features, aspects, time measurements, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

1. A method for converting a floor of a packing rack into a horizontal transfer lift, the method comprising:
(i) providing a packing rack having at least one floor, each floor comprising:
a first rod, a second rod, a third rod, a fourth rod forming a horizontal rectangular frame, wherein the first rod and the second rod are parallel to each other, while the third rod and the fourth rod are parallel to each other and orthogonal to the first rod and to the second rod;
a support base extending from the third rod to the fourth rod inside the rectangular frame;
a first beam, a second beam, a third beam, and a fourth beam extending vertically from respective corners of the rectangular frame;
(ii) disassembling one floor of the packing rack;
(iii) positioning the first rod vertically to form a first vertical column;
(iv) positioning the second rod vertically to form a second vertical column;
(v) joining the support base to the first vertical column and the second vertical column, such that the support base extends from the first vertical column to the second vertical column at a desired height;
(vi) joining a hooked motion unit to the support base, such that the hooked motion unit is configured to move horizontally along the support base, the hooked motion unit having a hook configured to be joined to straps attached to a target, such that a motion of hooked motion unit is configured to carry the target horizontally between a first location in a vicinity of the first vertical column and second location in a vicinity of the second vertical column.

2. The method of claim 1, further comprising:
joining the first vertical column to the third rod, such that the third rod is disposed horizontally below the first vertical column and provides a first base; and
joining the second vertical column to the fourth rod, such that the fourth rod is disposed horizontally below the second vertical column and provides a second base.

3. The method of claim 1, wherein the support base is telescopically extendible and contractable, the method further comprising between steps (v) and (vi):
telescopically extending or contracting the support base to adjust a horizontal length of the support base;
locking the support base at a desired horizontal length.

4. The method of claim 1, wherein the first rod and the second rod are telescopically extendible and contractable and wherein the method further comprises:
telescopically extending or contracting the first rod to adjust a vertical height of the first vertical column;
locking the first rod at a desired vertical height of the first vertical column;
telescopically extending or contracting the second rod to adjust a vertical height of the second vertical column; and
locking the second rod at a desired vertical height of the second vertical column.

5. The method of claim 1, wherein:
positioning the first rod vertically to form a first vertical column further comprises joining at least one of the first beam, the second beam, and the third rod to the first rod along longitudinal axes thereof to form the first vertical column;
positioning the second rod vertically to form a second vertical column further comprises joining at least one of the third beam, the fourth beam, and the fourth rod to the second rod along longitudinal axes thereof to form the second vertical column.

6. The method of claim 5, further comprising:
securing a bottom edge of the first vertical column to a floor;
securing a top edge of the first vertical column to a ceiling;
securing a bottom edge of the second vertical column to the floor;
securing a top edge of the second vertical column to the ceiling.

7. The method of claim 1, further comprising:
securing a bottom edge of the first vertical column to a floor;
securing a top edge of the first vertical column to a ceiling;
securing a bottom edge of the second vertical column to the floor;
securing a top edge of the second vertical column to the ceiling.

8. The method of claim 2, wherein:
the third rod comprises a first central attachment unit, a first rear attachment unit, and a first front attachment unit, which extend from a side of the third rod which extends parallel of a longitudinal axis of the third rod;
the first central attachment unit is between the first rear attachment unit and the first front attachment unit;
joining the first vertical column to the third rod comprises:
joining the first rod to the third rod via the first central attachment unit;
joining a first end of the first beam to the third rod obliquely via the first rear attachment unit, such that a second end of the first beam touches the first rod;
joining the second end of the first beam to the first rod;
joining a first end of the second beam to the third rod obliquely via the first front attachment unit, such that a second end of the second beam touches the first rod;
joining the second end of the second beam to the first rod;
the fourth rod comprises a second central attachment unit, a second rear attachment unit, and a second front attachment unit, which extend from a side of the fourth rod which extends parallel of a longitudinal axis of the fourth rod;
the second central attachment unit is between the second rear attachment unit and the second front attachment unit;
joining the second vertical column to the fourth rod comprises:
joining the second rod to the fourth rod via the second central attachment unit;
joining a first end of the third beam to the fourth rod obliquely via the second rear attachment unit, such that a second end of the third beam touches the second rod;
joining the second end of the third beam to the second rod;
joining a first end of the fourth beam to the fourth rod obliquely via the second front attachment unit, such that a second end of the fourth beam touches the second rod;
joining the second end of the fourth beam to the second rod.

9. The method of claim 1, wherein the hooked motion unit comprises:
a board;
at least one roller joined to a same surface of the board and extending out of the board; and
the hook, joined to the board;
wherein joining a hooked motion unit to the support base comprises placing the at least one roller on top of the support base, such that a rolling of the roller causes the hooked motion unit to travel along the support base.

10. The method of claim 9, wherein the hooked motion unit comprises a motor configured to selectively rotate the at least one roller in any one of two directions.

11. A kit for selectively constructing a floor of a packing rack and a horizontal transfer lift, the kit comprising a first rod, a second rod, a third rod, a fourth rod, a support base, a first beam, a second beam, a third beam, and a fourth beam, and a hooked motion unit, wherein:
in a configuration of the floor of the packing rack:
the first rod, the second rod, the third rod, and the fourth rod form a horizontal rectangular frame, wherein the first rod and the second rod are parallel to each other, while the third rod and the fourth rod are parallel to each other and orthogonal to the first rod and to the second rod;
the support base extends from the third rod to the fourth rod inside the rectangular frame;
the first beam, the second beam, the third beam, and the fourth beam extend vertically from respective corners of the rectangular frame;
in a configuration of the horizontal transfer lift;
the first rod is disposed vertically to form a first vertical column;
the second rod is disposed vertically to form a second vertical column;
the support base is joined to the first vertical column and to the second vertical column, such that the support base extends from the first vertical column to the second vertical column at a desired height;
the hooked motion unit is joined to the support base, such that the hooked motion unit is configured to move horizontally along the support base, the hooked motion unit having a hook configured to be joined to straps attached to a target, such that a motion of hooked motion unit is configured to carry the target horizontally between a first location in a vicinity of the first vertical column and second location in a vicinity of the second vertical column.

12. The kit of claim 11, wherein in the configuration of the horizontal transfer lift:
the first vertical column is joined to the third rod, such that the third rod is disposed horizontally below the first vertical column and provides a first base; and
the second vertical column is joined to the fourth rod, such that the fourth rod is disposed horizontally below the second vertical column and provides a second base.

13. The kit of claim 11, wherein the support base is telescopically extendible and contractable to adjust a horizontal length of the support base, and is lockable at a desired horizontal length.

14. The kit of claim 11, wherein the first rod and the second rod are telescopically extendible and contractable and in the configuration of the horizontal transfer lift:
the first rod is telescopically extendable or contractable to adjust a vertical height of the first vertical column;
the first rod is lockable the at a desired vertical height of the first vertical column;
the second rod is telescopically extendable or contractable to adjust a vertical height of the second vertical column;
the second rod is lockable the at a desired vertical height of the second vertical column.

15. The kit of claim 11, wherein:
the first vertical column is formed by joining at least one of the first beam, the second beam, and the third rod to the first rod along longitudinal axes;
the second vertical column is formed by joining at least one of the third beam, the fourth beam, and the fourth rod to the second rod along longitudinal axes thereof.

16. The kit of claim 15, wherein in the in the configuration of the horizontal transfer lift:
a bottom edge of the first vertical column is securable to a floor;
a top edge of the first vertical column to is securable a ceiling;
a bottom edge of the second vertical column is securable to the floor;
a top edge of the second vertical column is securable to the ceiling.

17. The kit of claim 11, wherein in the in the configuration of the horizontal transfer lift:
a bottom edge of the first vertical column is securable to a floor;
a top edge of the first vertical column to is securable a ceiling;
a bottom edge of the second vertical column is securable to the floor;
a top edge of the second vertical column is securable to the ceiling.

18. The kit of claim 12, wherein:
the third rod comprises a first central attachment unit, a first rear attachment unit, and a first front attachment unit, which extend from a side of the third rod which extends parallel of a longitudinal axis of the third rod;
the first central attachment unit is between the first rear attachment unit and the first front attachment unit;
in the in the configuration of the horizontal transfer lift:
the first rod is joined to the third rod via the first central attachment unit;
a first end of the first beam is joined to the third rod obliquely via the first rear attachment unit, such that a second end of the first beam touches the first rod;
the second end of the first beam to joined the first rod;
a first end of the second beam is joined to the third rod obliquely via the first front attachment unit, such that a second end of the second beam touches the first rod;
the second end of the second beam is joined to the first rod;
the fourth rod comprises a second central attachment unit, a second rear attachment unit, and a second front attachment unit, which extend from a side of the fourth rod which extends parallel of a longitudinal axis of the fourth rod;
the second central attachment unit is between the second rear attachment unit and the second front attachment unit;
in the configuration of the horizontal transfer lift:
the second rod is joined to the fourth rod via the second central attachment unit;
a first end of the third beam is joined to the fourth rod obliquely via the second rear attachment unit, such that a second end of the third beam touches the second rod;
the second end of the third beam is joined to the second rod;
a first end of the fourth beam is joined to the fourth rod obliquely via the second front attachment unit, such that a second end of the fourth beam touches the second rod;
the second end of the fourth beam is joined to the second rod.

19. The kit of claim 1, wherein the hooked motion unit comprises:
a board;
at least one roller joined to a same surface of the board and extending out of the board; and
the hook, joined to the board;
wherein in the configuration of the horizontal transfer lift, the at least one roller is placed on top of the support base, such that a rolling of the roller causes the hooked motion unit to travel along the support base.

20. The kit of claim 19, wherein the hooked motion unit comprises a motor configured to selectively rotate the at least one roller in any one of two directions.
